(19) United States
(12) Patent Application Publication
(10) Pub. No.: US 2009/0193809 A1
(43) Pub. Date: Aug. 6, 2009

(54) METHOD AND SYSTEM TO FACILITATE COMBINED CYCLE WORKING FLUID MODIFICATION AND COMBUSTION THEREOF

(76) Inventors: Mark Stewart Schroder, Greenville, SC (US); Mark Allan Hadley, Greenville, SC (US); Richard Anthony DePuy, Burnt Hills, NY (US); Todd Stanley Nemec, Guilderland, NY (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/025,437

(22) Filed: Feb. 4, 2008

(51) Int. Cl. F02C 3/22; B23P 11/00; F02C 6/00

(52) U.S. Cl. 60/726; 29/700; 60/39.48; 60/39.182

(57) ABSTRACT

A method of assembling a combustion system includes providing a gas turbine engine that includes a gas turbine section coupled downstream from a combustion chamber and coupling a source of oxygen to the gas turbine engine such that a stream of oxygen discharged from the source facilitates displacing nitrogen in the working fluid of the gas turbine engine and facilitates decreasing emissions generated within the gas turbine engine.

### BACKGROUND OF THE INVENTION

The present invention relates generally to combustion systems, and more particularly, to methods and systems that provide a stream of oxygen enriched fluid and a stream of nitrogen enriched fluid for use in a gas turbine engine.

At least some known industrial facilities include combustion systems that operate by combusting a stream of inlet air with a stream of fuel to produce an exhaust stream. At least some of the known combustion systems include a heat recovery steam generator that uses exhaust gases discharged from a gas turbine engine to produce an amount of steam. The steam is channeled through a steam turbine for the production of power. Known combustion systems may also include heat exchangers, flow control valves, and generators. Moreover, at least some known systems also include an air compressor that provides a compressed stream of inlet fluid to the gas turbine engine.

At least some known gas turbine engines include a compressor, a gas turbine section, and a combustion chamber defined between the compressor and the gas turbine section. The combustion chamber ignites a mixture of a stream of fuel with a stream of compressed air. Generally, the stream of compressed air provided for the combustion process includes the multiple constituents of air, including oxygen and nitrogen. However, the presence of nitrogen in the combustion process may contribute to the production of harmful emissions, including nitrogen oxide (NOx). To facilitate improving the emission efficiency during the combustion process, at least some known systems suggest using a more pure stream of fluid for use in the combustion process. However, the additional component needed to provide the purified stream of fluid increases the complexity of the overall system, and increases the amount of waste generated by components within the system. As such, the operational and maintenance costs of such systems are increased by such components and the overall efficiency of the system may be decreased.

### BRIEF DESCRIPTION OF THE INVENTION

In one aspect, a method of assembling a combustion system is provided. The method includes providing a gas turbine engine comprising a gas turbine section coupled downstream from a combustion chamber. The method further comprises coupling a source of oxygen to the gas turbine engine such that a stream of oxygen discharged from the source facilitates displacing nitrogen in the working fluid of the gas turbine engine and facilitates decreasing emissions generated within the gas turbine engine.

In another aspect, a combustion system is provided. The system includes a gas turbine engine and a source of oxygen coupled in flow communication with the gas turbine engine and configured to channel oxygen to the gas turbine engine to facilitate displacing nitrogen in combustion gases channeled to the gas turbine engine and to facilitate reducing emissions generated within the gas turbine engine.

In a further aspect, a combined cycle power system is provided. The power system includes at least one source of oxygen. The power system further includes a first gas turbine engine coupled in flow communication with the at least one source of oxygen. The gas turbine engine is downstream from the at least one source of oxygen and receives a stream of oxygen discharged from the at least one source for combustion. The stream of oxygen facilitates displacing nitrogen in the working fluid of the gas turbine engine and facilitates reducing emissions generated within the gas turbine engine. The power system also includes at least one heat recovery steam generator coupled in flow communication downstream from the gas turbine engine. The heat recovery steam generator is coupled in flow communication upstream from a steam turbine.

### BRIEF DESCRIPTION OF THE DRAWINGS

FIG. 1 is a schematic diagram of an exemplary gas turbine engine; and

FIG. 2 is a schematic diagram of an exemplary combined cycle power system that may be used with the gas turbine engine shown in FIG. 1.

### DETAILED DESCRIPTION OF THE INVENTION

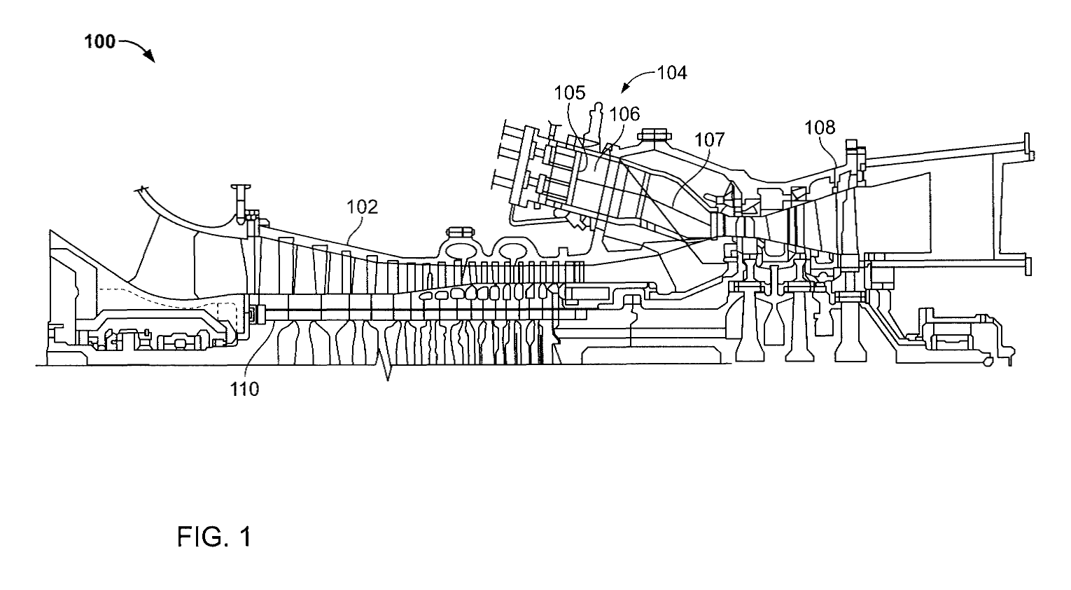

FIG. 1 is a schematic illustration of an exemplary gas turbine engine 100. In the exemplary embodiment, engine 100 includes a compressor 102 and a combustor assembly 104. Combustor assembly 104 includes a combustor assembly head 105 providing fuel into combustion chamber 106 that includes a centerline 107 that extends therethrough. In the exemplary embodiment, engine 100 includes a plurality of combustor assemblies 104. Combustor assembly 104, and, more specifically, combustion chambers 106 are coupled downstream from, and in flow communication with, compressor 102. Engine 100 also includes a gas turbine engine section 108 and a compressor/turbine shaft 110 (sometimes referred to as a rotor). In the exemplary embodiment, combustion chamber 106 is substantially cylindrical and is coupled in flow communication with gas turbine engine section 108. Turbine 108 is mechanically coupled to, and drives, shaft 110. Compressor 102 is also rotatably coupled to shaft 110. In the exemplary embodiment, combustor 104 is a dry low nitrogen oxide (NO_{X}), or DLN-type combustor, specifically, a Dry Low NOx series combustor system commercially available from General Electric Company. Alternatively, combustor 104 may be any combustor that facilitates operation of engine 100 by combining any “fuel” type with oxygen or any oxygen containing fluid as described herein.

In operation, air flows through compressor 102 and a substantial amount of the resulting compressed air is supplied to combustor assembly 104. Assembly 104 is also in flow communication with a fuel source (not shown in FIG. 1) and channels fuel and air to combustion chamber 106. In the exemplary embodiment, combustor assembly 104 ignites and combusts fuel, such as, for example, natural gas or fuel oil, within combustion chamber 106. A high temperature combustion gas stream (not shown in FIG. 1) is generated within chamber 106. Alternatively, assembly 104 combusts fuels that include, but are not limited to, process gas and/or synthetic gas (syngas). Combustor chambers 106 channels the combustion gas stream to turbine 108 along centerline 107 wherein thermal energy is converted to mechanical rotational energy.

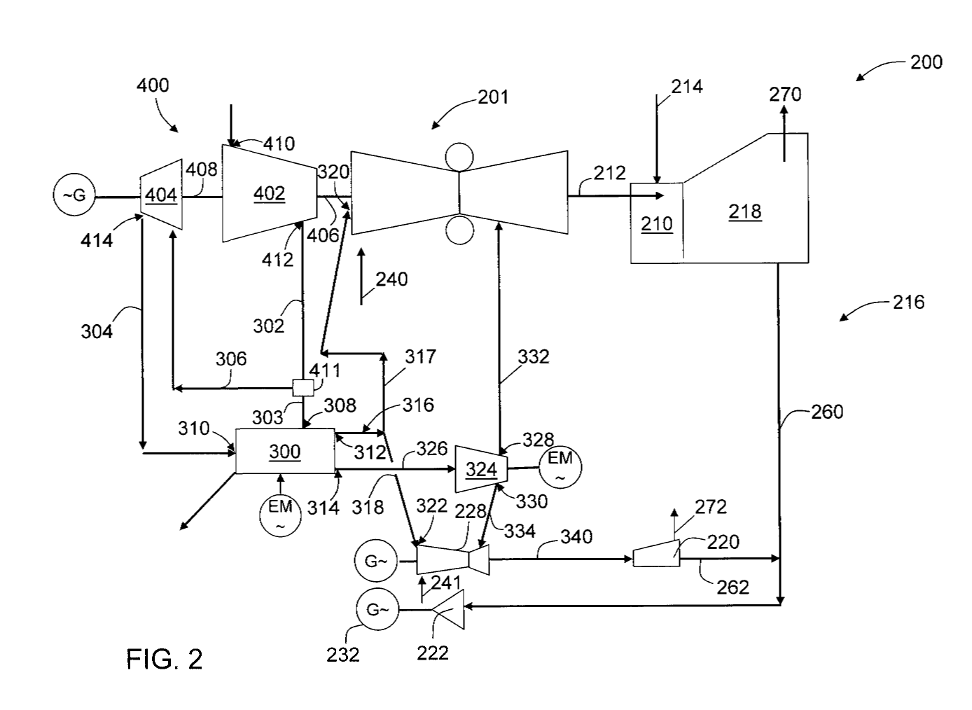

FIG. 2 is a schematic diagram of an exemplary combined cycle power system 200 that may be used with a gas turbine engine, such as gas turbine engine 100 (shown in FIG. 1). In the exemplary embodiment, system 200 includes a duct-firing device 210 that is coupled in flow communication downstream from gas turbine engine 201. In the exemplary embodiment, duct-firing device 210 combusts exhaust flow discharged from gas turbine engine 201, as described in more detail below.

In the exemplary embodiment, system 200 also includes a steam generation system 216. Specifically, in the exemplary embodiment, system 216 includes a first heat recovery steam generator (HRSG) 218 and a second HRSG 220. In one embodiment, first HRSG 218 contains an internal heat transfer apparatus (not shown) used to create steam using the hot exhaust flow from the gas turbine engine 201. A second HRSG 220 also contains a second heat transfer apparatus (not shown) performing the same energy transfer mechanism and technique to create steam. In the exemplary embodiment, first HRSG 218 and second HRSG 220 are coupled in flow communication with steam turbine 222.

An air separation unit (ASU) 300, in the exemplary embodiment, is included within system 200 and is coupled in flow communication with a compressor system 400. ASU 300 may be any commercially available type which separates the primary constituents of air, such as nitrogen and oxygen. Alternatively, ASU 300 may be any source of oxygen, such as processing plants, bio-mass, or exhaust gases from combustion processes. In one embodiment, compressor system 400 is coupled in flow communication with ASU 300 via a first air supply conduit (not shown) and a second air supply conduit (not shown). In the exemplary embodiment, compressor system 400 includes a first compression apparatus or main air compressor (MAC) 402. Specifically, in the exemplary embodiment, MAC 402 is a low-pressure, axial compressor (LPC). Alternatively, any compression apparatus that facilitates operation of compressor system 400 as described herein may be used. In the exemplary embodiment, gas turbine engine 201 is used to power compressor system 400, including MAC 402. In the exemplary embodiment, gas turbine engine 201 is mechanically coupled to MAC 402 via a shaft 406.

In the exemplary embodiment, MAC 402 is coupled to a boost air compressor (BAC) 404 via a shaft 408. In the exemplary embodiment, BAC 404 is a GE Nuovo Pignone, six-stage, centrifugal air compressor. Alternatively, BAC 404 may be any compressor that facilitates operation of compressor system 400 as described herein. In one embodiment, BAC 404 includes an inter- and an after-cooling heat exchanger (not shown) that is coupled in flow communication to BAC 404. The heat exchanger receives at least a portion of pressurized air stream from MAC 402, removes at least some heat from the air stream, and discharges a cooled air stream to BAC 404.

MAC 402 includes an inlet portion 410 that receives air from ambient. Alternatively, inlet portion 410 may receive air that is at a higher pressure than nominal atmospheric pressure after having passed through any type of supercharging device (not shown) that pressurizes ambient air prior to entering MAC 402. MAC 402 also includes a plurality of stages (not shown) that cooperate with an exit volute 412 to facilitate forming discharge air stream 302 that is at an elevated pressure. In the exemplary embodiment, a heat exchanger 411 is coupled downstream from exit volute 412 to facilitate cooling discharge air stream 302 and to facilitate reducing design power requirements associated with BAC 404. Moreover, the heat exchanger facilitates maintaining operations within a predefined temperature range defined by components downstream from MAC 402, including, but not limited to, ASU 300. Included within heat exchanger 411 are the necessary valves (not shown within 411) which perform the appropriate control of flow streams exiting MAC 402 and being channeled to BAC 404 or ASU 300.

ASU 300 is coupled in flow communication with MAC 402 and BAC 404. In the exemplary embodiment, ASU 300 is a refrigeration, cycle-based system that produces primarily a first stream 316 of at least 50% pure oxygen for use in gas turbines 201 and 228, and a second stream 326 that contains nitrogen for use as coolant in gas turbines 201 and 228. In the exemplary embodiment, ASU 300 includes respective first and a second exit portions 312 and 314 that channel the oxygen-enriched product stream 316 to gas turbine engines 201 and 228, and the nitrogen-enriched product stream 326 to compressor 324.

In operation, air is fed to MAC 402 from atmospheric environment via an air inlet 410. In one embodiment, an inlet filer (not shown), a filter housing (not shown), and optionally a supercharging device (not shown) are included to enable air to be drawn into the housing via the inlet filter.

MAC inlet portion 410 channels air to a plurality of stages that cooperate with exit volute 412 to facilitate forming discharge air stream 302. In one embodiment, a heat exchanger 411 and anti-surge device (not shown) are included within MAC 402, and the air stream is channeled to the heat exchanger via a conduit and the anti-surge device. Additionally, in such an embodiment, the heat exchanger facilitates reducing the temperature of the air stream channeled through the conduit before the stream enters ASU 300.

Air stream 302, after being discharged from MAC 402, is split into two air streams 303 and 306 via internal valves within heat exchanger 411 (not shown). The first air stream 303 is channeled to ASU 300 and enters ASU 300 via first inlet portion 308. The second air stream 306 is channeled to BAC 404 wherein air stream 306 is compressed by BAC 404 prior to being channeled to ASU 300. An air stream 304 exits BAC 404 via exit portion 414 and enters ASU 300 via second inlet portion 310. Alternatively, MAC 402 and BAC 404 may produce any number of air streams, at any operating pressure and at any flow rate that facilitates operation of ASU 300, as described herein. In the exemplary embodiment, MAC 402 and BAC 404 are both powered by gas turbine engine 201.

During operation, ASU 300 separates air streams 303 and 304 into an oxygen stream 316 and a nitrogen stream 326. The oxygen stream 316 exits ASU 300 via first exit portion 312 and is further divided into two streams 317 and 318. A first oxygen stream portion 317 is channeled to gas turbine engine 201 wherein it enters gas turbine engine 201 via air inlet 320. A second oxygen stream portion 318 is channeled to gas turbine engine 228 wherein it enters gas turbine engine 228 via air inlet 322.

The nitrogen stream 326 is discharged from ASU 300 via exit portion 314 and is channeled to compressor 324. The nitrogen stream 326 is pressurized to an operating pressure just above that necessary to enter gas turbine engine section 108. A first nitrogen stream portion 332 is discharged from compressor 324 via first exit portion 328 and is channeled to gas turbine engine 201 for use in cooling gas turbine engine 201. A second nitrogen stream portion 334 is discharged from nitrogen compressor 324 via second exit portion 330 and is channeled to gas turbine engine 228 for use in cooling gas turbine engine 228. Any excess nitrogen exiting ASU 300 is stored for future use and/or sold commercially.

First and second exhaust streams 212 and 340, respectively, exit first and second turbine engines 201 and 228, respectively. First gas turbine engine exhaust stream 212 is channeled to duct-firing device 210 wherein it is mixed for combustion with fuel stream 214 before being provided to first HRSG 218. In one embodiment, fuel stream 214 is a low cost and/or low BTU fuel stream. First HRSG 218 receives boiler feedwater (not shown) for use in heating the boiler feedwater into steam. The second gas turbine engine exhaust stream 340 exits gas turbine engine 228 and enters second HRSG 220. Second HRSG 220 receives boiler feedwater (not shown) for use in heating the boiler feedwater into steam.

The first and second steam streams 260 and 262 exit first HRSG 218 and second HRSG 220, respectively, and are each channeled to steam turbine 222 wherein the thermal energy in the steam is converted to rotational energy. The rotational energy is transmitted to generator 232 via a rotor (not shown), wherein generator 232 converts the rotational energy to electrical energy for transmission to at least one load, including, but not limited to, an electrical power grid. The steam is condensed and is then returned as boiler feedwater. Excess gases and steam 270 and 272, respectively, are exhausted from first HRSG 218 and second HRSG 220, respectively, to the atmosphere.

The methods and apparatus described herein enable a stream of air to be separated into an oxygen stream and a nitrogen stream for use in the operation of facilities that include combustion systems. Specifically, a higher oxygen concentration supplied to the gas turbine inlet flow or gas turbine working fluid, facilitates reducing NOx emissions, because the gas turbine receives a lower concentration of nitrogen in the working fluid. The reduction of NOx emissions facilitates enhancing economic benefits in regions where the secondary market for NOx credits is active or power plant permit requirements dictate the need for reduced NOx emissions. Moreover, a nitrogen stream facilitates increasing the efficiency of the overall plant by eliminating the need for internal bleeding of the gas turbine engine working fluid. Also, the somewhat higher molecular weight of the working fluid, due to the higher oxygen concentration, may facilitate increasing the flow-rate of working fluid through the gas turbine engines. Injecting nitrogen from the ASU system into the gas turbines to act as a turbine coolant facilitates increasing the electrical power generation at higher energy conversion levels. Moreover, increasing the oxygen concentration in the working fluid facilitates providing an oxygen-enriched exhaust stream that may be supplied to a conventional duct-burning process prior to entering the heat recovery steam generator. Duct-burning facilitates additional steam generation, and thus, overall electricity generation. A higher oxygen content exhaust flow in a duct-burning apparatus facilitates improving overall combustion efficiencies of duct-burning. This process facilitates increasing the overall plant operating efficiency. The description above is meant to cover a specific example of the general process for altering the composition of the working fluid within a thermodynamic cycle (Brayton in this embodiment) to improve the thermal, mechanical, electrical or emission efficiencies within an industrial plant and should not be found limited to the specific embodiment described.

Exemplary embodiments of air separation and combustion as associated with industrial facilities are described above in detail. The methods and systems are not limited to the specific embodiments described herein nor to the specific illustrated combined cycle combustion systems and industrial facilities, but rather, steps of the method and/or components of the system may be utilized independently and separately from other steps and/or components described herein. Further, the described method steps and/or system components can also be defined in, or used in combination with, other methods and/or systems, and are not limited to practice with only the method and system described herein. The description above is meant to cover a specific example of the general process for altering the composition of the working fluid within a thermodynamic cycle (Brayton cycle in this embodiment) to improve the thermal, mechanical, electrical, or emission efficiencies within an industrial plant and should not be found limited to the specific embodiment described.

While the invention has been described in terms of various specific embodiments, those skilled in the art will recognize that the invention can be practiced with modification within the spirit and scope of the claims.

What is claimed is:

1. A method of assembling a combustion system, said method comprising:
providing a gas turbine engine, the gas turbine engine comprising a gas turbine section coupled downstream from a combustion chamber; and
coupling a source of oxygen to the gas turbine engine such that a stream of oxygen discharged from the source facilitates displacing nitrogen in the working fluid of the gas turbine engine and facilitates decreasing the emissions generated within the gas turbine engine.

2. A method in accordance with claim 1 further comprising coupling at least one compressor assembly in flow communication with the source of oxygen to provide pressurized air to the source of oxygen.

3. A method in accordance with claim 1 further comprising extracting at least a portion of the working fluid from the gas turbine engine.

4. A method in accordance with claim 2 further comprising coupling the gas turbine engine to the at least one compression assembly, such that the gas turbine engine drives the at least one compression assembly.

5. A method in accordance with claim 1 further comprising coupling the gas turbine engine to a duct-firing device, such that exhaust from the gas turbine engine is channeled into the duct-firing device.

6. A combustion system comprising:
a gas turbine engine; and
a source of oxygen coupled in flow communication with said gas turbine engine and configured to channel oxygen to said gas turbine engine to facilitate displacing nitrogen in combustion gases channeled to said gas turbine engine and to facilitate reducing emissions generated within said gas turbine engine.

7. A combustion system in accordance with claim 6, wherein said source of oxygen comprises an air separation unit.

8. A combustion system in accordance with claim 7, wherein said air separation unit separates air flow entering said air separation unit into a first stream having an oxygen-enriched content and a second stream having a nitrogen-enriched content.

9. A combustion system in accordance with claim 8, wherein a first stream is an oxygen-enriched stream that is channeled to said gas turbine engine to facilitate combustion, and a second stream is a nitrogen-enriched stream that is channeled to said gas turbine engine to facilitate cooling of said gas turbine engine.

10. A combustion system in accordance with claim 7 further comprising at least one compressor assembly configured to provide pressurized air to said air separation unit.

11. A combustion system in accordance with claim 10, wherein said at least one compression assembly comprises a main air compressor and a boost air compressor coupled in flow communication with said air separation unit.

12. A combustion system in accordance with claim 7, wherein said air separation unit comprises a refrigeration cycle based system.

13. A combustion system in accordance with claim 10, wherein said gas turbine engine is mechanically coupled to said at least one compressor assembly.

14. A combustion system in accordance with claim 6 further comprising least one heat recovery steam generator coupled downstream from said gas turbine engine.

15. A combustion system in accordance with claim 14 further comprising a duct-firing device coupled between said gas turbine engine and said at least one heat recovery steam generator.

16. A combined cycle power system comprising:
at least one source of oxygen;
a first gas turbine engine coupled in flow communication with said at least one source of oxygen, said gas turbine engine is downstream from said at least one source of oxygen and receives a stream of oxygen discharged from said at least one source for combustion, wherein the stream of oxygen facilitates displacing nitrogen in the working fluid of the gas turbine engine and facilitates reducing emissions generated within said gas turbine engine; and
at least one heat recovery steam generator coupled in flow communication downstream from said gas turbine engine, said at least one heat recovery stream generator coupled in flow communication upstream from a steam turbine.

17. A combined cycle power system in accordance with claim 16, wherein said source of oxygen comprises an air separation unit, wherein said air separation unit separates air flow entering said air separation unit into a first stream having an oxygen-enriched content and a second stream having a nitrogen enriched content.

18. A combined cycle power system in accordance with claim 17 further comprising a second gas turbine engine coupled in flow communication with said air separation unit, said second gas turbine engine is in flow communication with a second heat recovery steam generator.

19. A combined cycle power system in accordance with claim 17 further comprising at least one compression assembly to provide pressurized air to said at least one air separation unit, said at least one compression assembly comprising a main air compressor and a boost air compressor coupled in flow communication with said at least one air separation unit.

20. A combined cycle power system in accordance with claim 17 wherein said air separation unit is configured to discharge the first stream with an oxygen content of at least 50% pure oxygen and a second stream with a nitrogen content of at least 90% pure oxygen.
